(19) United States
(12) Patent Application Publication
(10) Pub. No.: US 2015/0213815 A1
(43) Pub. Date: Jul. 30, 2015

(54) SYNTHETIC ANTIFERROMAGNETIC READER

(71) Applicant: Seagate Technology LLC, Cupertino, CA (US)

(72) Inventors: Victor Boris Sapozhnikov, Minnetonka, MN (US); Taras Grigoryevich Pokhil, Arden Hills, MN (US); Mohammed Sharia Ullah Patwari, Eden Prairie, MN (US)

(73) Assignee: Seagate Technology LLC, Cupertino, CA (US)

(21) Appl. No.: 14/167,575

(22) Filed: Jan. 29, 2014

(51) Int. Cl. G11B 5/39; G11B 5/09

(52) U.S. Cl. CPC G11B 5/39; G11B 5/09

(57) ABSTRACT

Implementations disclosed herein provide for an apparatus, comprising a synthetic antiferromagnetic reader structure, wherein total moment of a pinned layer is substantially greater than total moment of a reference layer. In one implementation, the pinning strength of the pinned layer is substantially reduced.

### BACKGROUND

In electronic data storage devices, magnetic hard disc drives contain magnetic recording heads that read and write data encoded in tangible magnetic storage media. The magnetic recording heads may include a thin film multilayer structure exhibiting magnetoresistance. Magnetic flux detected from the surface of the magnetic storage media causes rotation of a magnetization vector of a sensing layer or layers within a magnetoresistive (MR) sensor within a magnetic recording head, which in turn causes a change in electrical resistivity of the MR sensor. The change in resistivity of the MR sensor can be detected by passing a current through the MR sensor and measuring the resulting change in voltage across the MR sensor. Related circuitry can convert the measured voltage change information into an appropriate format and manipulate that information to recover the data encoded on the magnetic storage media.

### SUMMARY

Implementations disclosed herein provide an apparatus comprising a synthetic antiferromagnetic structure, wherein total moment of a pinned layer is substantially greater than total moment of a reference layer. In one implementation, the pinning strength of the pinned layer is substantially reduced.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations and implementations as further illustrated in the accompanying drawings and defined in the appended claims.

### BRIEF DESCRIPTIONS OF THE DRAWINGS

FIG. 1 illustrates a plan view of an example disk drive assembly including the reader disclosed herein.

FIG. 2 illustrates an example three-dimensional view of magnetization and magnetization rotation in a reader.

FIG. 3 illustrates an example graphical depiction of a free layer angle derivative of the reader in FIG. 2 during downtrack readback of a media transition.

FIG. 4 illustrates an example graphical depiction of a reference layer angle derivative of the reader in FIG. 2 during downtrack readback of a media transition.

FIG. 5 illustrates a graphical depiction of a signal derivative in an example reader during downtrack readback of a media transition.

FIG. 6 illustrates an example graphical depiction of PW50 vs. SAF pinning for a reader with different SAF ratios.

### DETAILED DESCRIPTION

There is an increasing demand for high data densities and sensitive sensors to read data from magnetic storage media. As the data densities on the magnetic storage media increases, the Giant Magnetoresistive (GMR) sensors that have increased sensitivity consist of two soft magnetic layers separated by a thin conductive, non-magnetic spacer layer, such as copper. Tunnel Magnetoresistive (TMR) sensors provide an extension to GMR in which the electrons travel with their spins oriented perpendicularly to the magnetic layers across a thin insulating tunnel barrier.

In a TMR sensor, a sensor stack may be positioned between a top shield and a bottom shield. The shields isolate the sensor stack from unwanted electromagnetic interference and yet permit the sensor stack to be affected by magnetic fields of a data bit directly under the sensor.

In one implementation of a magnetoresistive (MR) sensor (also referred to as a “read sensor”), the sensor stack may include a seed layer, an antiferromagnetic (AFM) layer, a synthetic antiferromagnetic (SAF) structure, a tunneling barrier layer, a free layer (FL), and a capping layer. The SAF structure may consist of multiple thin ferromagnetic layers, one or more layer pairs being separated by a thin nonmagnetic layer. For example, the SAF structure may include a pinned layer (PL), a coupling spacer layer, and a reference layer (RL). The coupling spacer layer may be made of material, such as Ruthenium. The PL is a first soft magnetic layer with inhibited rotation. On one side of the SAF structure, an AFM layer may be positioned adjacent to the PL of the SAF structure to prevent it from rotating. On the other side of the SAF structure, a FL (a second soft layer that rotates freely in response to an external field) may be positioned near the RL.

In one implementation, the PL is pinned such that the moment of the magnetization of the PL is perpendicular to an air-bearing surface (ABS) of the sensor stack. Similarly, the RL is pinned such that the moment of the magnetization of the RL is also perpendicular to the ABS. However, the direction of the magnetization of the RL and the PL are opposite, or 180 degrees apart from each other.

On the other hand, the FL is biased such that the moment of magnetization of the FL is substantially at 90 degrees from the pinning of the PL and RL. In other words, the direction of the magnetization of the FL is parallel to the surface of the ABS. Specifically, the direction of the magnetization of the FL is generally parallel to the surface of the ABS and in the cross-track direction in a direction perpendicular to the movement of the MR sensor over the magnetized media. The direction of the magnetic moment of the RL and the direction of the magnetic moment of the FL rotate in opposite directions during a change in magnetic field from a recording medium. Specifically, during the operation of the MR sensor, the MR sensor is exposed to a range of magnetic fields from the recording medium, from positive to negative fields. As the field changes, the direction of the magnetic moments of the various magnetic layers of the stack rotates, thus creating a signal.

As the MR sensor moves on the surface of the magnetic recording media, the pinning of the PL generally stays at substantially close to 90 degrees to the ABS of the MR sensor. However, depending on the magnetization of the magnetic recording media, the magnetization of the FL changes, thus changing the angle between the magnetization of the RL and the FL, which produces a signal in proportion to the tunneling magnetoresistance generated by the recording media.

To operate the MR sensor properly, the MR sensor should be stabilized against the formation of edge domains because domain wall motions results in electrical noise that makes data recovery difficult. One way to obtain stabilization is by positioning biasing structure, such as permanent magnets (PM) with high coercive field (i.e., hard magnets), on each side of the MR sensor along cross-track direction. The field from the PM stabilizes the sensor and prevents edge domain formation, as well as provides proper bias. For example, the MR sensor is positioned between the PMs such that the PMs push the pinning of the RL and the PL in the opposite direction.

Using the AFM/SAF structure in the MR sensor as disclosed above increases the shield-to-shield spacing (SSS) of the reader. As the pulse width fluctuations PW50 of MR sensors, which determine the signal-to-noise (SNR) ratio in a recording system, depends on the SSS of the header, achieving a lower SSS results in lower PW50 and increased SNR. However, approaches to reduce the SNR by reducing the SSS have been largely exhausted. The implementations disclosed herein provide alternative approaches to increase the SNR of the MR sensor. Specifically, implementations disclosed herein provide for an MR sensor, comprising a SAF structure, wherein moment of the pinned layer is greater than moment of the reference layer. As a result of the described design, the SAF is significantly unbalanced in favor of the PL. Moreover, the pinning strength is substantially weakened, to allow substantially PL magnetization rotation during readback.

The magnetic moments of the SAF structure may be balanced to enable as little movement in the composite SAF structure moment as possible during a readback operation. In such an implementation, the total moment as given by the magnetic moment thickness MrT (which is the product of the magnetic moment (Mr) per unit volume of a ferromagnetic material and the physical thickness (T) of the ferromagnetic material) of a PL and a RL in a SAF structure are substantially the same or similar and the direction of the magnetic moments of the PL and the RL are substantially opposite to each other. As a result, the torques applied to the magnetic moments of the PL and the RL during a readback operation cancel each other out, resulting in an overall desired value of torque substantially near zero.

In the disclosed implementations, the SAF structure is unbalanced in favor of the PL, in that the magnetic moment of the PL is substantially higher than the magnetic moment of the RL. When the SAF is unbalanced in favor of PL, the MrT of the PL is increased, and as a result the magnetic torque in the PL in the presence of a media field is higher than the magnetic torque in the RL in the presence of a media field. As the MrT is the product of the magnetic moment and the thickness, the SAF structure may be unbalanced by changing either the thickness or the magnetic moment of the PL. Thus, in one implementation, the magnetic moment of the PL may be increased compared to the moment of the RL to unbalance the SAF structure. In another implementation, the thickness of the PL may be increased compared to the thickness of the RL to unbalance the SAF structure.

In an alternative implementation of a SAF structure disclosed herein, the pinning strength of the PL is substantially reduced in order to achieve increased SAF rotation in the presence of a media field. The RL is coupled to the PL and as a result, when the pinning strength of the PL is reduced, a given media field strength is able to rotate the RL more as a result of reduced pinning strength of the PL. As a result of the unbalancing of the SAF structure and/or the reduced pinning strength, the pulse width PW50 is reduced. Thus, the implementations disclosed herein allow reducing PW50 and increasing SNR for the recording system without reducing the SSS of the MR sensor. In yet another implementation, both the pinning strength of the PL is substantially reduced in addition to the unbalanced SAF structure. In yet another alternative implementation, both the pinning strength of the PL is substantially reduced in addition to the unbalanced SAF structure.

The unbalance of the MrT is quantified by a SAF ratio (SAF_R)=MrT of PL/MrT of RL. Generally, SAF structure is balanced such that SAF_R is approximately close to 1.0. While, the SAF_R may vary somewhat around 1.0, SAF structures with SAF_R above 1.1 are considered to be substantially unbalanced. For example, if the SAF_R is 2, the MrT of PL is twice the amount of the MrT of RL, as such, the total moment MrT of a pinned layer in the SAF structure is substantially greater than total moment MrT of a reference layer in such SAF structure.

In one implementation, the SAF_R may be increased to at or above 1.1 from a range of 0.85-1.0. The SAF_R may be increased to at or above 1.1 by increasing ratio of the magnetic moment (Mr) of the pinned layer and magnetic moment (Mr) of the reference layer above 1.1, while keeping the thicknesses of the pinned layer and the reference layer similar. In an alternative implementation, the SAF_R may be increased to at or above 1.1 by increasing ratio of the thickness of the pinned layer and thickness of the reference layer above 1.1, while keeping the magnetic moments (Mr) of the pinned layer and the reference layer similar. Furthermore, the pinning strength (measured in erg/cm²) in an implementation may be reduced as much as 3-10 times.

The implementations disclosed herein may be used in conjunction with a variety of different types of MR sensors (e.g., anisotropic magnetoresistive (AMR) sensors, TMR sensors, GMR sensors, etc.). Accordingly, the implementations discussed may also be applicable to new MR sensor designs that are based on new physical phenomena such as lateral spin valve (LSV), spin-hall effect (SHE), spin torque oscillation (STO), etc.

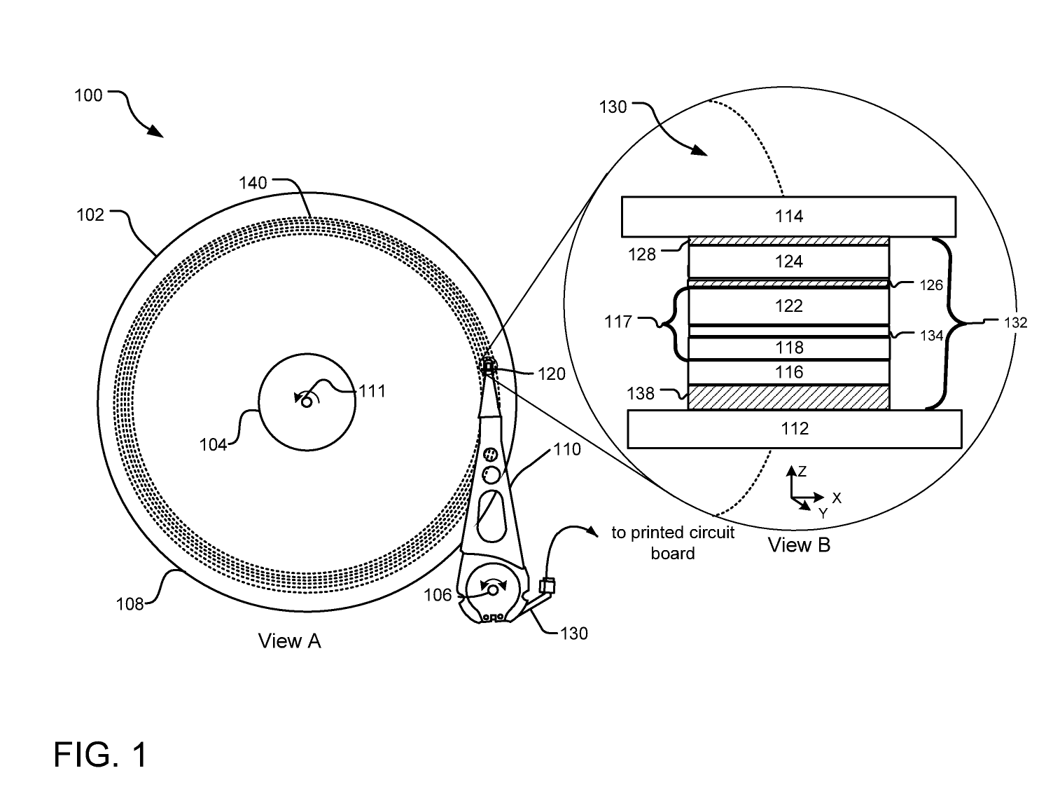

FIG. 1 illustrates a plan view of an example disk drive assembly 100. The example disk drive assembly 100 includes a slider 120 on a distal end of an actuator arm 110 positioned over a media disk 108. A rotary voice coil motor that rotates about an actuator axis of rotation 106 is used to position the slider 120 on a data track (e.g., a data track 140) and a spindle motor that rotates about disk axis of rotation 111 is used to rotate the media disk 108. Referring specifically to View A, the media disk 108 includes an outer diameter 102 and inner diameter 104 between which are a number of data tracks, such as a data track 140, illustrated by circular dotted lines. A flex cable 130 provides the requisite electrical connection paths for the slider 120 while allowing pivotal movement of the actuator arm 110 during operation.

The slider 120 is a laminated structure with a variety of layers performing a variety of functions. The slider 120 includes a writer section (not shown) and one or more MR sensors for reading data off of the media disk 108. View B illustrates a side of an example MR sensor 130 that faces an ABS of the media disk 108 when the disk drive assembly 100 is in use. Thus, the MR sensor 130 shown in view B may be rotated by about 180 degrees about (e.g., about a z-axis) when operationally attached to the slider 120 shown in View A.

The MR sensor 130 utilizes magnetoresistance to read data from the media disk 108. While the precise nature of the MR sensor 130 may vary widely, a TMR sensor is described as one example of an MR sensor that can be utilized with the presently-disclosed technology.

The MR sensor 130 includes a sensor stack 132 positioned between a top shield 114 and a bottom shield 112. The top shield 114 and the bottom shield 112 isolate the sensor stack 132 from electromagnetic interference, primarily z-direction (down-track) interference, and serve as electrically conductive first and second electrical leads connected to processing electronics (not shown). In one implementation, the bottom shield 112 and the top shield 114 permit the sensor stack 130 to be affected by magnetic fields of a data bit directly under the MR sensor 130 while reducing or blocking magnetic field interference of other, adjacent data bits. Therefore, as the physical size of bits continues to decrease, the shield-to-shield spacing (SSS) between the bottom shield 112 and the top shield 114 should also be decreased. As the SSS decreases, the PW50 also decreases.

The sensor stack 132 may include a seed layer 138 that initiates a desired grain structure in other layers of the sensor stack 132. The sensor stack 132 also includes an AFM layer 116 and a SAF structure 117. The SAF structure 117 includes a pinned layer (PL) 118, a coupling spacer layer 134, and a reference layer (RL) 122. The PL 118 is a soft magnetic layer with a magnetic orientation biased in a given direction by the AFM layer 116. The coupling spacer layer 134 is adjacent to the PL 118 and separates the PL 118 from the RL 122. The RL 122 includes at least two soft magnetic layers laminated together and anti-ferromagnetically coupled to the PL 118 by the coupling spacer layer 134. Because of this coupling, the magnetic moment of the RL 122 and the PL 118 are generally oriented normal to the plane of FIG. 1 and antiparallel to one another.

The MR sensor 100 further includes a free layer (FL) 124 that has a magnetic moment that is free to rotate under the influence of an applied magnetic field in the range of interest. According to another implementation, two or more soft magnetic layers of the FL 124 are laminated together by a thin layer of amorphous magnetic material. The amorphous magnetic material increases a coupling strength of the soft magnetic layers and improves stability of the MR sensor 100.

A tunneling barrier layer 126 separates the RL 122 from the FL stack 124. The tunneling barrier layer 126 is sufficiently thin to enable quantum mechanical electron tunneling between the RL 122 and the FL 124. The electron tunneling is electron-spin dependent, making the magnetic response of the read head 130 a function of the relative orientations and spin polarizations of the FL 124 and of the SAF structure 117 (i.e., the structure including the RL 122, the PL 118, and the coupling spacer layer 134). The lowest probability of electron tunneling occurs when the magnetic moments of the SAF structure 117 and the free layer stack 124 are antiparallel. Accordingly, the electrical resistance of the sensor stack 132 changes in response to an applied magnetic field.

The sensor stack 132 further includes a capping layer 128. The capping layer 128 magnetically separates the free layer stack 124 from the top shield 114. The capping layer 128 may include several individual layers (not shown). Additionally, the sensor stack 132 may be located between two permanent magnets (PM) (not shown) on two sides of the sensor stack 132 along cross-track direction (along x-axis).

The data bits on the media disk 108 are magnetized in a direction normal to the plane of FIG. 1, either into the place of the figure, or out of the plane of the figure. Thus, when the MR sensor 130 passes over a data bit, the magnetic moment of the free layer is rotated either into the plane of FIG. 1 or out of the plane of FIG. 1, changing the electrical resistance of the MR sensor 130. The value of the bit being sensed by the MR sensor 130 (e.g., either 1 or 0) may therefore be determined based on the current flowing from a first electrode coupled to the AFM layer 116 and to a second electrode coupled to the capping layer 128.

According to one implementation, the MrT of the PL 118 in the SAF structure 117 is greater than MrT of the RL 122 in the SAF structure 117. As provided above, as a result of the disclosed design, the SAF is significantly unbalanced in favor of the PL 118. The increased MrT of the PL 118 may be achieved by either increasing the moment of the PL 118 or by increasing the thickness of the PL 118 compared to the moment of the RL 122 or the thickness of the RL 122, respectively. Furthermore, the pinning strength of the PL 118 may also be significantly reduced in order to achieve significant SAF rotation in the presence of media field. As a result of the unbalancing of the SAF structure 117 and/or the reduced pinning strength, the pulse width fluctuation PW50 of MR sensor 130 is reduced, which results in reduced signal-to-noise (SNR) ratio in a recording system using the MR sensor 117. Thus, the MR sensor 130 provides increased SNR for the recording system without reducing the SSS of the sensor stack 117.

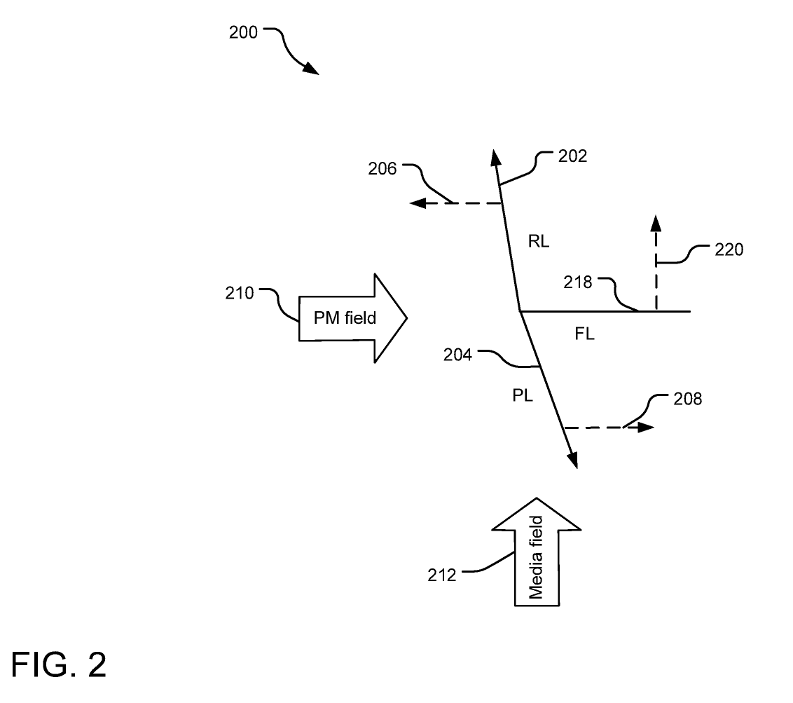

FIG. 2 illustrates a two-dimensional view 200 of magnetization and magnetization rotation in a reader in an implementation disclosed herein. The magnetizations of the PL and RL of a SAF structure in a sensor stack are illustrated by solid arrows and the rotation of the magnetizations are illustrated by dotted arrows. Specifically, the magnetization of the RL is illustrated by 202 and the magnetization 202 of the PL is disclosed by 204 and the rotation of the RL magnetization is illustrated by 206 and the rotation of the PL magnetization 204 is illustrated by 208. As illustrated the magnetization 202 of the RL and the magnetization 204 of the PL are substantially opposite in direction to each other (although not completely opposite or at 180 degrees). On the other hand, the FL of the sensor structure is biased such that the FL magnetization 218 is substantially at 90 degrees from the PL magnetization 204 and the RL magnetization 202. The media field 212 causes the FL magnetization 218 to rotate as illustrated by direction of rotation 220.

In one implementation, where the SAF structure is unbalanced in favor of the PL, the PL magnetization 204 has a higher moment compared to the RL magnetization 202. Furthermore, the pinning strength of the PL is reduced such that in presence of a media field 212, the PL magnetization 204 rotates more freely in the direction 208. The PL is pinned by an AFM layer at the bottom of the SAF structure including the PL.

The SAF structure may be located along cross-track direction between PMs that produce a PM field 210. The PM field 210 biases the FL with a magnetic moment parallel to the plane of the figure and generally oriented horizontally. This bias prevents the FL magnetization 218 from drifting (such drifting may introduce noise into the data). The PM field 210 bias is sufficiently small, however, the FL magnetization 218 can change in response to an applied media field 212 of a data bit stored on a data disc.

The media field 212 exerts force on the PL magnetization 204 in a counterclockwise direction and on the RL magnetization 202 in a clockwise direction. In one implementation, the SAF structure is significantly unbalanced in favor of the PL and the pinning strength of the PL is substantially reduced. For example, the SAF structure may be unbalanced by providing a PL that is thicker than the RL. As a result, the effective combined torque on the PL magnetization 204 and the RL magnetization 202 is counterclockwise. Furthermore, the reduced pinning strength results in increased rotation of the RL magnetization 202 in the presence of the media field 212, in the same direction as the rotation 220 of the FL magnetization 218 but with a phase shift.

The data signal formed by the sensor stack is dependent on a pulse generated across RL and AFM (RL pulse) and a pulse generated across FL and AFM (FL pulse). As a result of the different downtrack location of SAF and FL, the RL pulse is phase shifted with respect to the FL pulse and in formation of the data field, the RL pulse is subtracted from the FL pulse mostly on one side. This leads to narrowing down of the data signal pulse on the RL side, resulting in reduced PW50.

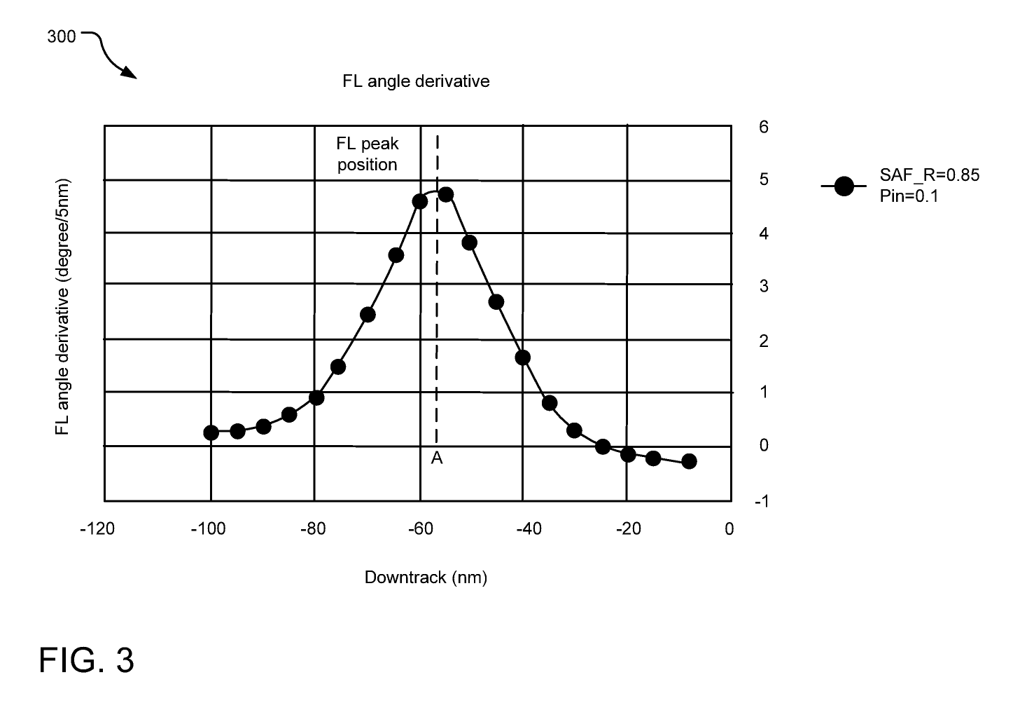

FIG. 3 illustrates a graph 300 of FL angle derivative (i.e., Δ FL angle/Δ position) as a function of the reader position in the down-track direction in a reader with unbalanced SAF structure as disclosed herein. Specifically, the graph 300 illustrates the change in the FL angle derivative as a function of change in the position of the reader (in nm) during a single transition of the reader over a data bit written into the media as the media is moving with respect to the reader. When the reader crosses the transition, the position of the FL magnetization changes, as reflected by the angle of the FL magnetization. The FL peak position, when the reader crosses the transition, is depicted as dotted line A at approximately −57 nm, with a FL magnetization angle derivative at approximately 4.8 degrees/5 nm in this implementation.

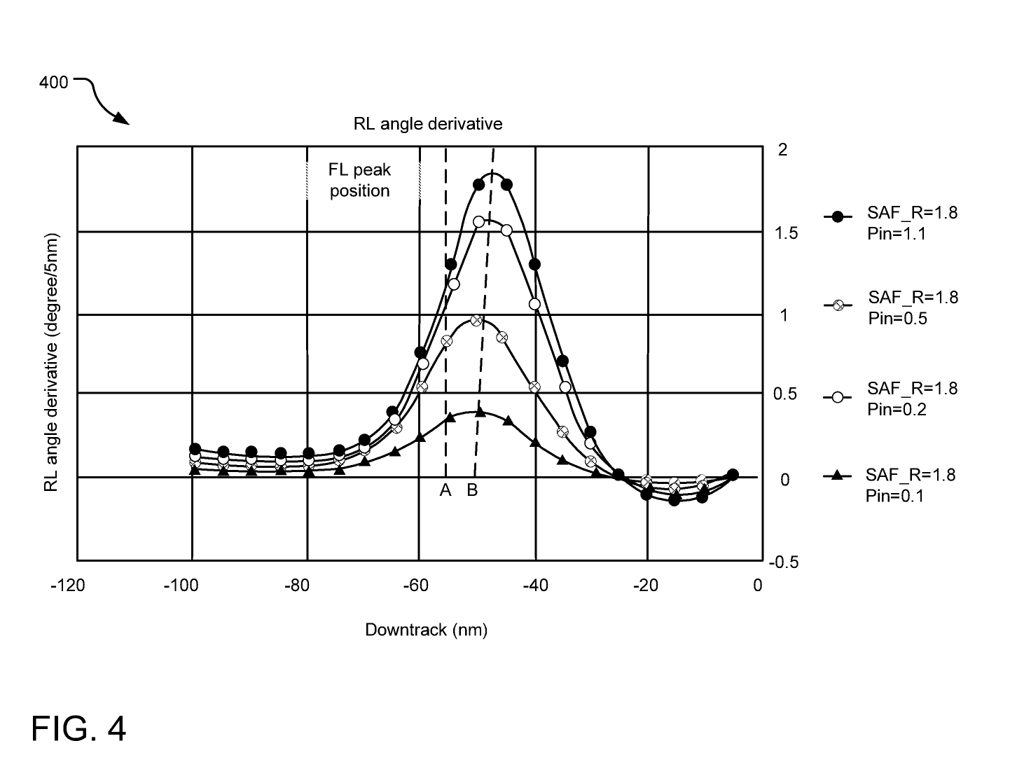

FIG. 4 illustrates a graph 400 of RL angle derivatives of a reader as a function of the reader position in the down-track direction in a reader with unbalanced SAF structure as disclosed herein. Specifically, the graph 400 illustrates the change in the RL angle derivative as a function of change in the position of the reader (in nm) during a single transition of the reader over a data bit written into the media as the media is moving with respect to the reader. The graph 400 illustrates such relation between the RL angle derivative and position of the reader for SAF ratio (MrT of PL/MrT of RL) of 1.8 for various different pinning strengths (1.1, 0.5, 0.2, and 0.1 erg/cm²).

The movement of the RL magnetization depends on the pinning strength of the SAF structure with lower pinning strength resulting in higher movement of the curve as illustrated in FIG. 4. The SAF pinning reduction and SAF rebalancing in favor of the PL, as disclosed herein, leads to higher movement of the RL magnetization and therefore, higher amplitude for the RL angle deviation in presence of the media field. As illustrated in FIG. 4, the movement of the RL magnetization is in the direction of the FL magnetization.

In signal formation, the RL pulse is shifted with respect to the FL pulse primarily on one side. As a result, the signal pulse is narrowed down on the RL side. The maximum of the RL magnetization angle derivative is shown by the dotted line B. The dotted line A is the position of the maximum FL magnetization angle derivative. Because the RL pulse moves in the same direction as the FL pulse, this design reduces change in the relative angle between the FL magnetization and the RL magnetization, primarily on the RL side.

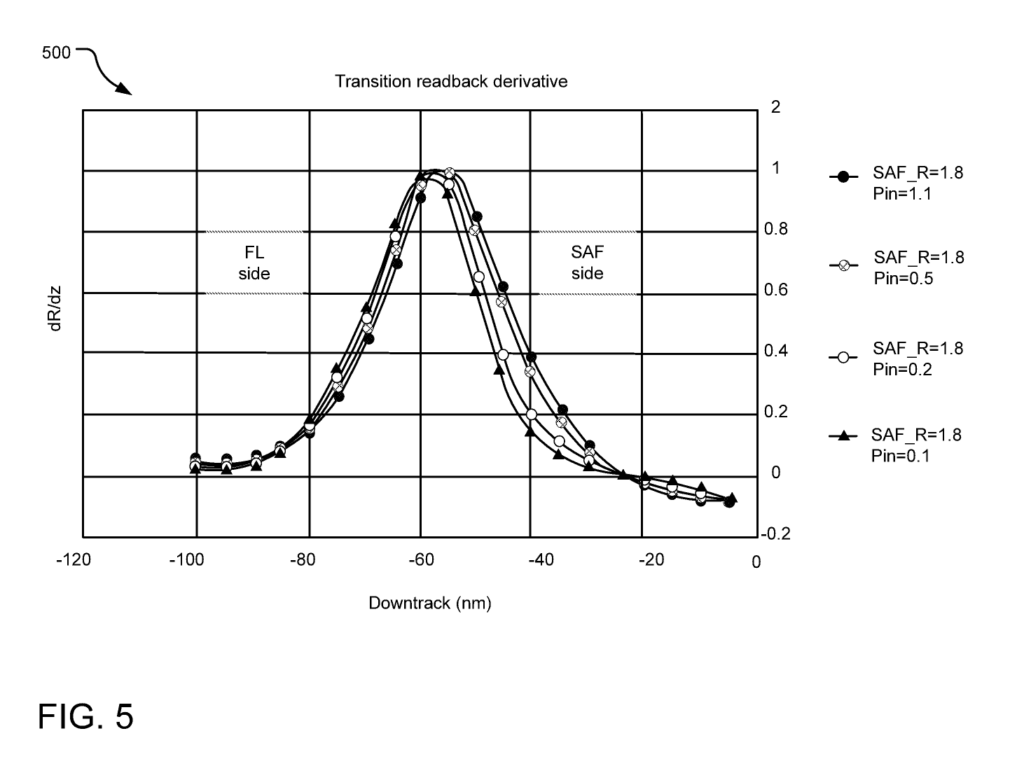

FIG. 5 illustrates a graph 500 of an example transition readback derivatives (pulse shapes, generally proportional to the FL-RL angle derivatives) as a function of the reader position in the down-track direction in a reader with unbalanced SAF structure as disclosed herein. The graph 500 illustrates such relation between the transition readback derivatives and position of the reader for SAF ratio (MrT of PL/MrT of RL) of 1.8 for various different pinning strengths (1.1, 0.5, 0.2, and 0.1 erg/cm²). As illustrated, the RL magnetization rotation in a reader with unbalanced SAF structure in favor of PL narrows down the reader pulse on the SAF side, resulting in narrower PW50.

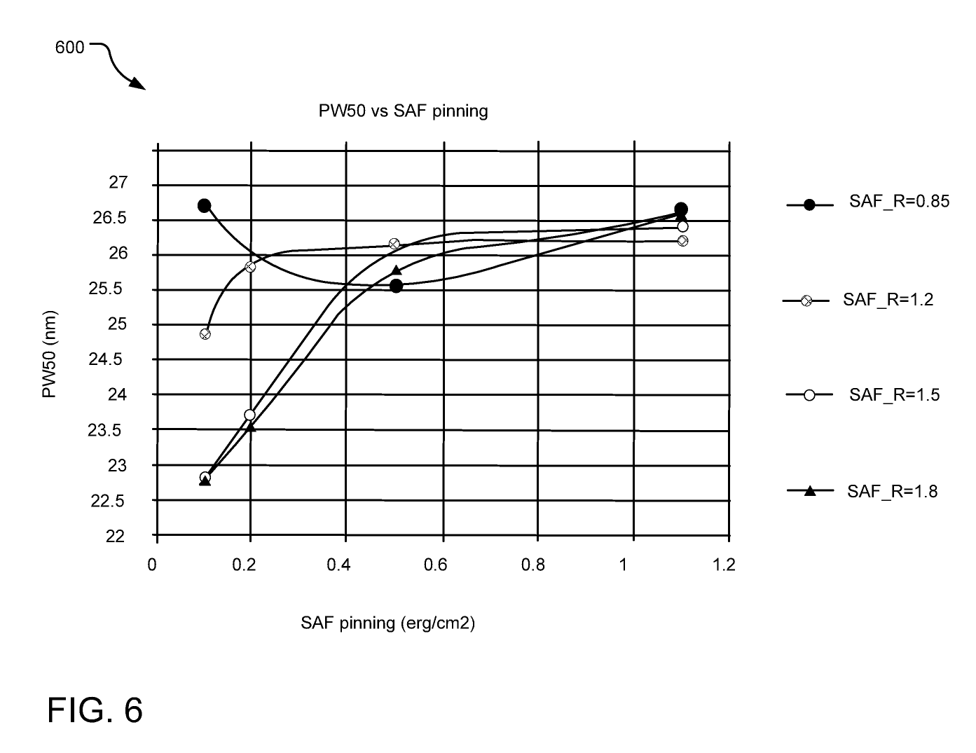

FIG. 6 illustrates a graph 600 of PW50 vs. SAF pinning in a reader with unbalanced SAF structure as disclosed herein for various SAF ratios (0.85, 1.2, 1.5, and 1.8). As illustrated, for lower pinning strengths, the reader with higher SAF ratio results in lower PW50. For example, with SAF ratio of 1.8 and SAF pinning strength lower than 0.2 erg/cm², the PW50 is as low as approximately 22.5-23 nm. Compared to that, with SAF ratio of 1.2 and similar pinning strength, the PW50 is approximately 25-25.5 nm. Thus, the disclosed implementations with increased SAF ratio can reduce PW50 by as much as 2-3 nm. Such reduction in PW50 is equivalent to the reduction in SSS of approximately 5-10 nm, which may be difficult to achieve. In other words, for values of SAF ratios substantially greater than 1.1 (such as SAF ratio of 1.2, 1.5, 1.8, etc.), the disclosed implementations provide significant reduction in the PW50.

The above specification, examples, and data provide a complete description of the structure and use of example implementations of the invention. Since many implementations of the invention can be made without departing from the spirit and scope of the invention, the invention resides in the claims hereinafter appended. Furthermore, structural features of the different implementations may be combined in yet another implementation without departing from the recited claims. The implementations described above and other implementations are within the scope of the following claims.

1. An apparatus, comprising:
a synthetic antiferromagnetic (SAF) structure, wherein a ratio of total moment MrT of a pinned layer in the SAF structure and total moment MrT of a reference layer in the SAF structure is substantially greater than 1.1, and wherein the pinned layer has a pinning strength substantially lower than 0.9 erg/cm².

2. The apparatus of claim 1, wherein magnetic moment (Mr) of the pinned layer is substantially greater compared to magnetic moment (Mr) of the reference layer and thickness of the pinned layer is similar to thickness of the reference layer.

3. The apparatus of claim 1, wherein thickness of the pinned layer is substantially greater compared to the thickness of the reference layer and magnetic moment (Mr) of the pinned layer is similar to magnetic moment (Mr) of the reference layer.

4. The apparatus of claim 1, wherein the ratio of MrT of the pinned layer and the MrT of the reference layer is substantially greater than 1.2.

5. (canceled)

6. The apparatus of claim 1, wherein the SAF structure is used in a sensor stack of an MR sensor.

7. The apparatus of claim 1, wherein the SAF structure is used in a pinned bottom shield.

8. The apparatus of claim 1, wherein ratio of magnetic moment (Mr) of the pinned layer and magnetic moment (Mr) of the reference layer is substantially greater than 1.2 and wherein thickness of the pinned layer is similar to thickness of the reference layer.

9. The apparatus of claim 1, wherein pinning strength of the SAF structure is substantially lower than 0.5 erg/cm².

10. A method of controlling the pulse width fluctuation (PW50) of a sensor stack by controlling a ratio of total moment MrT of a pinned layer having a pinning strength substantially lower than 0.9 erg/cm² and total moment MrT of reference layer in a synthetic antiferromagnetic (SAF) structure of the sensor stack, the ratio being increased to be substantially higher than 1.1.

11. The method of claim 10, wherein the ratio of the MrT of the pinned layer and the MrT of the reference layer is increased to be substantially higher than 1.2.

12. The method of claim 10, further comprising reducing pinning strength of the SAF structure substantially below 0.9 erg/cm².

13. The method of claim 10, wherein controlling the ratio of total moment MrT of the pinned layer and total moment MrT of reference layer further comprises controlling relative moment Mr of the pinned layer compared to moment of the reference layer.

14. The method of claim 10, wherein controlling ratio of total moment MrT of the pinned layer and total moment MrT of reference layer further comprises controlling relative thickness of the pinned layer compared to thickness of the reference layer.

15. A method of controlling the pulse width fluctuation (PW50) of a sensor stack by unbalancing a synthetic antiferromagnetic (SAF) structure of the sensor stack by having a ratio of total moment (MrT) of a pinned layer of the SAF having a pinning strength substantially lower than 0.9 erg/cm² and total moment (MrT) of a reference layer of the SAF above 1.1.

16. The method of claim 15, wherein unbalancing the SAF structure further comprises unbalancing the SAF structure in favor of a pinned layer to have higher total moment compared to total moment of a reference layer.

17. (canceled)

18. (canceled)

19. The method of claim 15, wherein unbalancing the SAF structure comprises unbalancing the SAF structure to have a total moment (MrT) ratio above 1.2.

20. The method of claim 19, wherein unbalancing the SAF structure further comprises increasing ratio of the magnetic moment (Mr) of the pinned layer and magnetic moment (Mr) of the reference layer above 1.5.
